(19) United States
(12) Patent Application Publication
(10) Pub. No.: US 2016/0116437 A1
(43) Pub. Date: Apr. 28, 2016

(54) MULTI-CHANNEL FLOW DIRECTION CONTROLLER FOR FREE-FLOW ELECTROPHORESIS APPARATUS

(71) Applicant: SHANGHAI JIAO TONG UNIVERSITY, Shanghai (CN)

(72) Inventors: Chengxi CAO, Shanghai (CN); Jian YAN, Shanghai (CN); Xiaoping LIU, Shanghai (CN); Chengzhang YANG, Shanghai (CN); Fanzhi KONG, Shanghai (CN); Liuyin FAN, Shanghai (CN)

(21) Appl. No.: 14/979,614

(22) Filed: Dec. 28, 2015

Related U.S. Application Data
(63) Continuation-in-part of application No. PCT/CN2013/084949, filed on Oct. 10, 2013.

(30) Foreign Application Priority Data
Jun. 28, 2013 (CN) 201310270196.1

(51) Int. Cl. G01N 27/447; B01D 57/02

(52) U.S. Cl. CPC G01N 27/44769; B01D 57/02

(57) ABSTRACT

A multi-channel flow direction controller for a free-flow electrophoresis apparatus, including a base and a propulsion member. The base is provided with a plurality of convex pieces. The propulsion member is provided with a plurality of narrow pieces. The convex pieces and the narrow pieces have the same length and number. One end of the base is provided with a groove, and one end of the propulsion member is disposed in the groove.

### CROSS-REFERENCE TO RELATED APPLICATIONS

This application is a continuation-in-part of International Patent Application No. PCT/CN2013/084949 with an international filing date of Oct. 10, 2013, designating the United States, now pending, and further claims priority benefits to Chinese Patent Application No. 201310270196.1 filed Jun. 28, 2013. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, and Cambridge, Mass. 02142.

### BACKGROUND OF THE INVENTION

1. Field of the Invention

The invention relates to an apparatus of biochemical engineering, and more particularly to a multi-channel flow direction controller for a free-flow electrophoresis apparatus.

2. Description of the Related Art

In existing free-flow electrophoresis apparatuses, the inlet or outlet of the separation chamber is provided with a plurality of hoses, and the flow directions of the hoses are controlled by three-way valves. The plurality of hoses occupies much space of the free-flow electrophoresis apparatus, and, as a result, the free-flow electrophoresis apparatus has a complex structure, and the recovery rate of the electrophoretic medium is low. In addition, the three-way valves cannot simultaneously change the flow directions.

### SUMMARY OF THE INVENTION

In view of the above-described problems, it is one objective of the invention to provide a multi-channel flow direction controller for a free-flow electrophoresis apparatus. The flow direction controller has a compact structure, occupies less space, and can efficiently, conveniently and simultaneously change the flow directions of fluids in the hoses, can control the flow resistance of the fluids in the hoses to be uniform, thus has a high recovery rate of electrophoretic mediums.

To achieve the above objective, in accordance with one embodiment of the invention, there is provided a multi-channel flow direction controller for a free-flow electrophoresis apparatus, comprising a base and a propulsion member. The base comprises a plurality of convex pieces. The propulsion member comprises a plurality of narrow pieces. The convex pieces and the narrow pieces have the same length and the same number. One end of the base is provided with a groove, and one end of the propulsion member is disposed in the groove.

In a class of this embodiment, the flow direction controller further comprises a fixing piece for the propulsion member, a first screw and a second screw. The fixing piece for the propulsion member is provided with a first through hole. One end of the base is provided with a first threaded hole. The first through hole and the first threaded hole are integrated via the first screw. Another end of the base is provided with a second threaded hole. Another end of the propulsion member is provided with a second through hole. The second through hole and the second threaded hole are integrated via the second screw. A rotational mode of the second screw is a manual mode or an automatic mode.

Before invention of the multi-channel flow direction controller, the outer diameter of the hoses must be known to determine intervals between the convex pieces, and intervals between the narrow pieces; and the number of the hose must be known to determine the number and length of the convex pieces. Meanwhile, two hoses can be disposed in parallel between two convex pieces, so that the number of controllable hoses is increased. One end of the base is provided with a groove to fix the propulsion member to prevent the propulsion member from deviating during a clamping process. The propulsion member is provided with a fixing piece to ensure the fixation of the propulsion member. The propulsion member moves forward and clamps the hoses as the second screw is screwed up, thus liquid flow in the hoses is cut off. On the contrary, liquid flow in the hoses is restored as the second screw is screwed off.

Compared with conventional technologies, the advantages of this multi-channel flow direction controller are as follows: the flow direction controller has a compact structure, occupies less space, and can simultaneously control the flow directions of fluids in the hoses; the flow direction controller can be controlled manually or automatically, is easy and convenient to operate, so it has a low operation cost.

### BRIEF DESCRIPTION OF THE DRAWINGS

FIG. 1 is a schematic diagram of a base of a multi-channel flow direction controller for a free-flow electrophoresis apparatus in Example 1;

FIG. 2 is a schematic diagram of a propulsion member of a multi-channel flow direction controller for a free-flow electrophoresis apparatus in Example 1;

FIG. 3 is a schematic diagram of a fixing piece for a propulsion member of a multi-channel flow direction controller for a free-flow electrophoresis apparatus in Example 1;

FIG. 4 is a schematic diagram showing an assembling of a multi-channel flow direction controller for a free-flow electrophoresis apparatus in Example 1;

FIG. 5 is a schematic diagram of a multi-channel flow direction controller for a free-flow electrophoresis apparatus in Example 1;

FIG. 6 is a schematic diagram of a base of a multi-channel flow direction controller for a free-flow electrophoresis apparatus in Example 2;

FIG. 7 is a schematic diagram of a propulsion member of a multi-channel flow direction controller for a free-flow electrophoresis apparatus in Example 2; and

FIG. 8 is a schematic diagram showing a multi-channel flow direction controller for a free-flow electrophoresis apparatus in Example 2.

In the figures, the following reference numbers are used: 1. Base; 2. First threaded hole; 3. Convex piece; 4. Groove; 5. Second threaded hole; 6. Propulsion member; 7. Narrow piece; 8. Second through hole; 9. Fixing piece for propulsion member; 10. First through hole; 11. First screw; and 12. Second screw.

### DETAILED DESCRIPTION OF THE EMBODIMENTS

For further illustrating the invention, experiments detailing a multi-channel flow direction controller for a free-flow electrophoresis apparatus are described below. It should be noted that the following examples are intended to describe and not to limit the invention.

### EXAMPLE 1

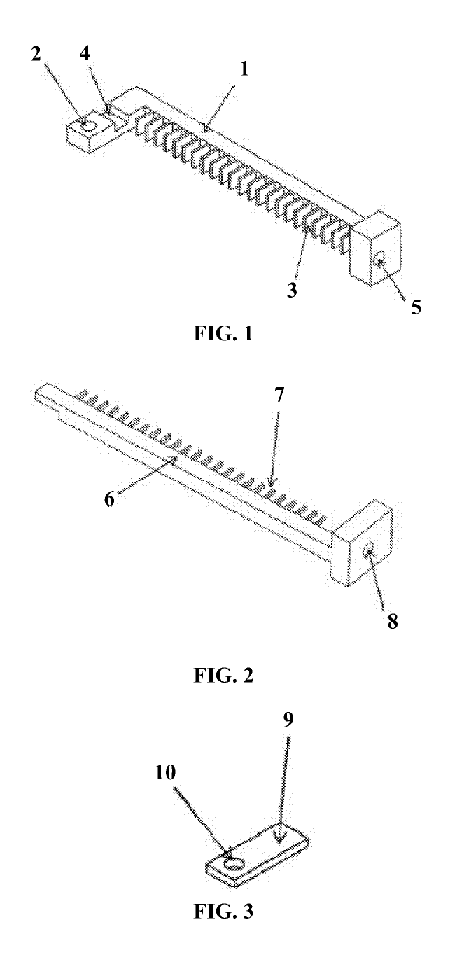

As shown in FIGS. 1-5, a multi-channel flow direction controller for a free-flow electrophoresis apparatus comprises a base 1, a propulsion member 6, a fixing piece of the propulsion member 9, a first screw 11 and a second screw 12. The base 1 comprises a plurality of convex pieces 3. The propulsion member 6 comprises a plurality of narrow pieces 7. The convex pieces 3 and the narrow pieces 7 have the same length and the same number. One end of the base 1 comprises a groove 4, and one end of the propulsion member 6 is disposed in the groove 4. The fixing piece 9 for the propulsion member comprises a first through hole 10. One end of the base 1 comprises a first threaded hole 2. The first through hole 10 and the first threaded hole 2 are integrated via the first screw 11. Another end of the base 1 comprises a second threaded hole 5. Another end of the propulsion member 6 comprises a second through hole 8. The second through hole 8 and the second threaded hole 5 are integrated via the second screw 12. The rotational mode of the second screw 12 is a manual mode.

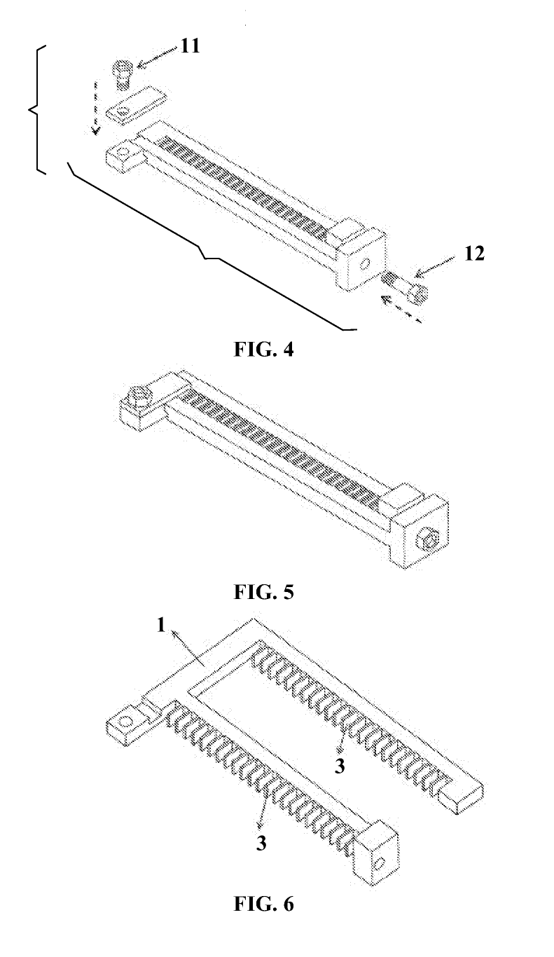

The hoses are disposed between the convex pieces 3 of the base 1, and the narrow pieces 7 of the propulsion member 6 are aligned with the convex pieces 3, as shown in FIG. 4. One end of the propulsion member is disposed in the groove 4 of the base 1. Then the fixing piece 9 is fixed by the first screw 11, so that the propulsion member can only move forward or backward in a straight line. Finally, the second screw 12 is screwed in to drive the propulsion member 6 to move forward to clamp the hoses and stop the liquid flow in the hoses.

### EXAMPLE 2

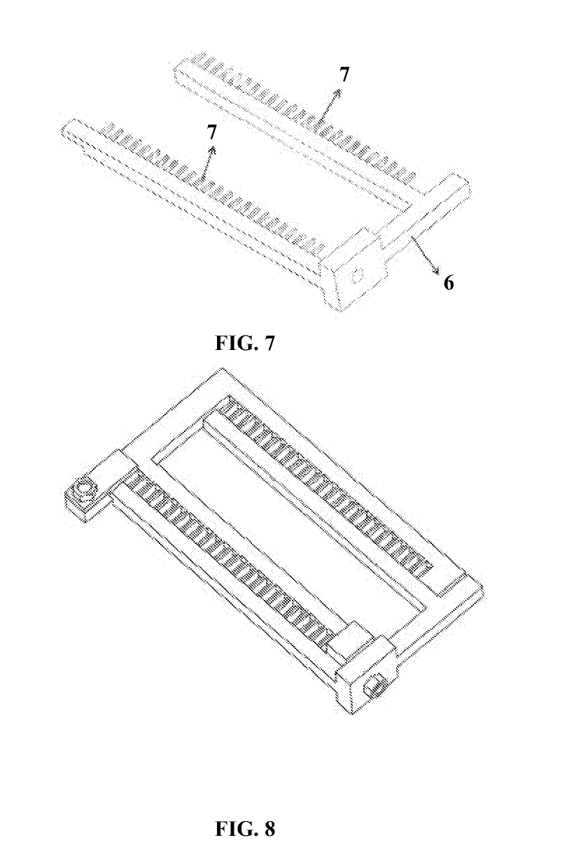

As shown in FIGS. 6-7, following the basic structure in Example 1, the base 1 comprises two rows of convex pieces 3, and the propulsion member 6 comprises two rows of narrow pieces 7. The two rows of convex pieces 3 are aligned with the two rows of narrow pieces 7, respectively. The second screw 12 drives the propulsion member 6 to move forward or backward. The structure is adapted to control double rows of hoses. Similarly, the convex pieces 3 and the narrow pieces 7 can be designed in three, four, or more rows.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A multi-channel flow direction controller for a free-flow electrophoresis apparatus, the controller comprising:
a) a base, the base comprising a plurality of convex pieces; and
b) a propulsion member, the propulsion member comprising a plurality of narrow pieces;
wherein
the convex pieces and the narrow pieces have the same length and the same number;
one end of the base is provided with a groove, and one end of the propulsion member is disposed in the groove.

2. The controller for claim 1, further comprising a fixing piece for the propulsion member and a first screw, the fixing piece for the propulsion member comprising a first through hole; wherein one end of the base is provided with a first threaded hole; the first through hole and the first threaded hole are integrated via the first screw.

3. The controller for claim 2, further comprising a second screw; wherein another end of the base is provided with a second threaded hole; another end of the propulsion member is provided with a second through hole; the second through hole and the second threaded hole are integrated via the second screw.

4. The controller for claim 3, wherein a rotational mode of the second screw is a manual mode or an automatic mode.
